(19) United States
(12) Patent Application Publication
(10) Pub. No.: US 2021/0171779 A1
(43) Pub. Date: Jun. 10, 2021

(54) LOW HEAT BUILD-UP UV-CURED VACUUM COATING SYSTEM IN DARK COLORS

(71) Applicant: George Melkonian, Federal Way, WA (US)

(72) Inventor: George Melkonian, Federal Way, WA (US)

(21) Appl. No.: 17/101,906

(22) Filed: Nov. 23, 2020

Related U.S. Application Data
(63) Continuation of application No. 15/821,615, filed on Nov. 22, 2017, now abandoned.
Application No. 15/821,615 is a continuation of application No. 14/127,378, filed on Mar. 12, 2014, now abandoned.
Application No. 14/127,378 is a continuation-in-part of application No. 13/135,317, filed on Jun. 30, 2011, now abandoned.

(51) Int. Cl. C09D 5/33; B32B 27/30; C09D 5/00; B32B 27/20; B32B 27/08; B32B 27/06

(52) U.S. Cl. CPC C09D 5/004; B32B 2307/734; C09D 5/006; B32B 27/20; B32B 27/08; B32B 27/065; Y10T 428/269; Y10T 428/249992; Y10T 428/31935; Y10T 428/31906; Y10T 428/249981; B32B 2307/416; B32B 2419/00; B32B 2307/712; B32B 2307/414; B32B 2264/067; B32B 2264/102; B32B 2264/10; B32B 2307/402; B32B 27/304

(57) ABSTRACT

A weatherable, low heat build-up, UV-cured vacuum coating for PVC or other extruded plastic profiles comprising a dark-colored pigment system that is substantially IR transparent, an IR reflective substrate, and a vacuum coating system for same.

### CROSS REFERENCE TO RELATED APPLICATIONS

This application is a continuation application claiming priority to U.S. application Ser. No. 15/821,615 filed Nov. 22, 2017, which is a continuation application claiming priority to U.S. patent application Ser. No. 14/127,378 filed Mar. 12, 2014, which is a National Stage patent application filed under 35 USC 371 claiming priority to PCT/US2012/000311 having an international filing date of 2 Jul. 2012, which claims priority to U.S. patent application Ser. No. 13/135,317 filed 30 Jun. 2011; the disclosures of each are incorporated herein by reference.

### TECHNICAL FIELD

The invention concerns extruded plastic profiles coated with a low heat build-up, UV-cured vacuum coating the method and apparatus for coating such extruded plastic profiles.

### BACKGROUND OF THE INVENTION

Milled wood products have formed the foundation for the fenestration, decking, venetian blinds, shutters, decking and remodeling industries for many years. Historically, ponderosa pine, fir, red wood, cedar and other coniferous varieties of soft woods have been employed with respect to the manufacture of residential window frames, residential siding, outer decking and exterior shutters as well as interior venetian blinds and shutters. Wood products of this type inherently possess the advantageous characteristics of high flexural modulus, good screw retention, easy workability (e.g., milling, cutting), easy paintability, and for many years, low cost. Conversely, wood products of this type have also suffered from poor weatherability in harsh climates potential insect infestation such as by termites, and high thermal conductivity. In addition, virgin wood resources have become scarce causing correspondingly high material costs.

In response to the above described disadvantages of milled wood products, the fenestration industry, in particular, adopted polyvinyl chloride (PVC) as a raw material. Hollow, lineal extrusions manufactured into window frames became an enormous success, particularly at the lower end of the price spectrum. The window frames made from hollow PVC lineals (often referred to as “vinyl windows”) have exhibited superior thermal conductivity, water absorption resistance, rot and insect resistance compared to painted ponderosa pine. Although such extrusions further enjoyed a significant cost advantage over comparable milled wood products, these PVC products had a significantly lower flexural modulus and higher coefficient of thermal expansion and were difficult to paint effectively. Similarly, hollow PVC lineals have replaced wood for Venetian blind and shutter frames, slats and related components having largely the same advantages and disadvantages as PVC window extrusions. Also, foamed polymer solid extrusions have been used to replace wood window frames and sashes, Venetian blind and shutter frames and slats. The foamed polymer extrusions may contain organic or inorganic fillers, such as wood flour and talc, respectively, where advantageous for improved physical properties such as stiffness and/or to reduce the cost of the extrusions.

As noted above, windows manufactured with wooden frames and sashes can easily be stained or painted virtually any color. Thus, the color of the window frame and sash could be chosen to accent or contrast with the color of the exterior of the house. The PVC products are typically available only in white or beige. Understandably, window and door profiles in dark colors, such as “Hunter Green” and “Bronze,” have long been demanded in the industry. Still, there is the significant issue of heat build-up, which largely accounts for the relative lack of dark colors in PVC windows and other products formed of extruded plastic lineals.

When referring to dark colors herein, the inventor is referring generally to colors with an Lh value between 13 and 40. For example, per ASTM 4726-02, dark brown is defined as a color with an Lh between 13 and 33, an ah between −1.0 and 6.0 and a bh between 1.0 and 6.5. Per AAMA 308-02, dark green is defined as a color with an Lh between 20 and 40, and ah between −20 and −2 and a bh between −2.0 and 4.0. The inventor defines the color red to have Lh values between 20 and 30, ah values between 13 and 23, and bh values between 6 and 12.

For example, it is well known in the vinyl window industry that PVC window frames will fail in unacceptably high numbers, exhibiting symptoms such as buckling, warping and sagging, if the window frames become too hot. The environmental factors typically causing a window frame to warm is a high ambient air temperature in addition to visible light and near infrared solar radiation. It can be shown that ASTM D4803, Predicted Heat Build-Up, is a good predictor of product performance related to heat induced PVC window failure. That is, it is known to the inventor what products have failed in the field, what products have not failed in the field, and what the ASTM D4803 predicted heat build-up values are for those products. It is known that the near infrared portion of solar radiation is a significant portion of the energy radiated from the sun and the properties of a pigment system related to this spectrum will effect what is known as the heat build-up of that pigment system.

In order to color a vacuum coating for application on an extrusion, various pigments are combined, typically by a color house, within a base where individual pigments absorb or reflect certain portions of the visible light spectrum causing the base to appear to be a certain predetermined color. Still, pigment systems that are the same color may have substantially different heat build-up characteristics as the near infrared portion of solar radiation is a significant portion of the energy radiated from the sun and the near infrared portion of solar radiation is invisible to the human eye.

In general, the art of coatings, capstocks, laminates, and mono-color extrusion has been concerned with using highly IR reflective pigment systems. Even state-of-the-art IR reflective pigment systems still limit the useful color spectrum to lighter shades, and darker colors using such state of the art pigment systems will lead to excessive heat build-up and, ultimately, product failure in the field. Thus, there is a need for dark colors that will not build up excessive heat and therefore fail at the point of use. application Ser. No. 11/291,494, with inventor Paul M. Wells is co-owned by Assignee of this application and discloses an extrusion method for a low heat build-up capstock system, and the '494 application is incorporated by reference.

Other means to apply a layer of color to a hollow vinyl profile or a foamed vinyl extrusion include coatings. In general, vacuum coating processes are limited in useful color spectrum due to heat build-up constraints. In addition, coating and laminate application typically requires the use of hazardous materials and is subject to various safety and environmental regulations due to VOC's in water-borne or solvent paints or vacuum coatings. Many coatings in particular are easily damaged during fabrication and installation and extensive touch-up is often required after the finished window or door unit is installed. For example, the waterborne paints that have been suitable for PVC windows and other products formed of extruded plastic lineal have had surface hardness of 2 B and are difficult to repair in the field. This surface hardness makes damage to the painted surface during the window installation and shipment unfortunately common.

Last, mono-color extrusions are also common in the art. As with capstocks, coatings, and laminates, the useful color spectrum is limited to colors that do not readily absorb in the IR spectrum and therefore do not build up sufficient heat to distort the body of the extrusion. Typically, mono-color extrusions are seen in lighter shades and pastels where heat build-up is not a problem and where the required amount of pigments does not unduly increase the cost of the extrusion.

### SUMMARY OF THE INVENTION

It is therefore an object of the invention to provide a heat build-up resistant extrudate with a dark-colored vacuum coating comprising an IR reflective substrate portion formed of a thermoplastic resin that is substantially reflective of solar infrared radiation, a dark-colored vacuum coating that is formed of a UV-cured vacuum coating that is significantly transmissive of solar infrared radiation and that covers at least a portion of the reflective substrate, and where the extrudate exhibits a predicted horizontal heat build-up under ASTM D4803 of less than about 58.degree. Fahrenheit.

It is a further object of the invention to provide a method of producing a low heat build-up extrudate with a dark-colored vacuum coating comprising coating a portion of the surface of an IR reflective substrate, formed of a thermoplastic resin that is substantially reflective of solar infrared radiation, with a UV-cured vacuum coating using a vacuum coating gate and mask apparatus, where the vacuum coating gate and mask apparatus is supplied by a vacuum pump and supply apparatus and curing the vacuum coating in a primary UV oven.

It is a still further object of the invention to provide for a vacuum coating line for the production of a low heat build-up extrudate with a dark-colored vacuum coating.

In a preferred embodiment of the inventive low heat build-up extrudate with a dark-colored vacuum coating, the extrudate comprises an IR reflective substrate portion formed of a thermoplastic resin containing between about 8 and 11 parts TiO₂ per hundred resin that is substantially reflective of solar infrared radiation, a dark-colored vacuum coating between about 0.6 and 0.8 mils thick that is significantly transmissive of solar infrared radiation and that covers at least a portion of the reflective substrate, where the extrudate exhibits a predicted horizontal heat build-up under ASTM D4803 of less than about 52.degree. Fahrenheit.

### BRIEF DESCRIPTION OF THE DRAWINGS

FIG. 1 is a plan view of a vacuum coating line of a type used with the inventive method.

FIG. 2 is a top view of a gate and shroud for use with the vacuum coating line used with the inventive process.

FIG. 3 is a plan view of the gate of FIG. 2 for use with the vacuum coating line used with the inventive process.

### DETAILED DESCRIPTION OF THE PREFERRED EMBODIMENTS

The inventor and persons of ordinary skill in the art of extruding plastics for the fenestration industry understand that ASTM D 4803, Predicted Heat Build-Up, ASTM Standard Test Method for Predicting Heat Buildup in PVC Building Products (1997), is a good predictor of product performance as it relates to thermal failures due to excessive temperatures within a structural extrusion from absorbing solar radiation primarily in the near-infrared spectrum (NIR). That is, it is known to the inventor what products have failed in the field, what products have not failed in the field, and what the ASTM D4803 predicted heat build-up (PHBU) values are for those products. ASTM D4803 gives a predicted heat build-up in degrees Fahrenheit above ambient, e.g., a PHBU of 50.degree. F. would indicate a test specimen temperature that is 50.degree. F. greater than test ambient air temperature. Usefully, it is possible to tailor an IR transparent vacuum coating and IR reflective substrate for predicted heat build-up values that are either known or predicted to have acceptable performance in the field. The inventor is aware of significant numbers of heat build-up related failures of structural PVC fenestration components in use in the continental United States where the horizontal PHBU values were 59.degree. F. and believes that a horizontal PHBU of 56.degree. F. or less for a production PVC structural fenestration product would appropriately limit the likelihood of such failures. A PHBU of 56.degree. F. or less may be appropriate for temperate regions not subject to high solar radiation. For products other than fenestration products, such as Venetian blinds and shutters, or where the base resin is more or less tolerant of increased temperatures, the acceptable heat build-up values could be increased or decreased for reasons well understood in the plastics extrusion industry in a manner further described hereinbelow. As is well understood by one of ordinary skill in the plastics extrusion arts, the heat resistance of a product can be increased by changes made to the base resin such as by the use of heat resistant PVC. These prior art solutions can be used in combination with the present invention to allow a useable fenestration product where the horizontal PBHU values are higher than the values recommended above.

It should be understood that further reduction of the PBHU will decrease the likelihood of heat build-up related failures. Still, excessive resistance to heat build-up is of no value to an end user in that the only goal is to ensure that the fenestration product or other extruded product does not warp, buckle or sag in use. Therefore, cost increases entailed in lowering the PHBU value or by increasing the heat resistance of the base extrusion must be justified as significantly lessening the likelihood of product failure.

Further, a vacuum coating process, producing coated, dark-colored PVC or other extruded plastic window components, having a zero VOC is of significant advantage due to the improved environmental conditions in the production process. This has been achieved using an UV-cured, “100% solid” or “100% transfer” process. This vacuum coating will preferably have a surface hardness of 4H and would PHBU of 56.degree. F. or less in dark colors. This 4H surface hardness limits damage to the coated surface during the window installation and shipment.

The present invention utilizes a UV-cured, “100% solid” or “100% transfer” vacuum coating process with a dark colored coating for color that is significantly NIR transparent rather than NIR reflective, and relies on an NIR reflective substrate for the NIR reflectance. The PVC or other extruded plastic profile is used as the NIR reflective substrate allowing the NIR transparent vacuum coating to impart both the dark color while achieving the necessary low heat build-up properties of the coated profile. A preferred embodiment of the invention has a vacuum coated hollow, thin-walled polyvinyl chloride resin based extrusion. Salient differences from the prior art is that this PVC substrate must be tailored for near infrared solar (NIR) reflectance and the dark-colored vacuum coating must be substantially transmissive of NIR as is more thoroughly discussed below. Another preferred embodiment of the invention comprises a foamed PVC-based extrusion extruded by a base extruder, an NIR reflective substrate layer formed by a capstocking extruder, and a dark-colored vacuum coating that is significantly transmissive of solar infrared radiation (NIR). A further embodiment would provide comprises a primary extruder that extrudes a hollow, thin-walled extrusion, preferably formed of PVC resin and not necessarily NIR reflective, an NIR reflective substrate layer formed by a capstocking extruder, and a dark-colored vacuum coating that is significantly transmissive of solar infrared radiation (NIR).

Tailoring the heat build-up performance of an extrusion is conducted by essentially three means. First, the thickness of the dark-colored vacuum coating is manipulated to minimize IR absorbance as NIR initially passes through the dark-colored vacuum coating and as it is reflected off of the substrate back through the dark-colored vacuum coating. This manipulation must also be done in a manner that preserves the visual color of the vacuum coating. Second, the substrate is manipulated to provide the requisite IR reflectance, most commonly by manipulating the loading of TiO2 but also with consideration of other substrate constituents. Third, the pigments in the dark-colored vacuum coating required to impart particular colors should be optimized to minimize their absorbance of NIR. In practice, all three means must be optimized for a particular vacuum coating/color/substrate combination to yield a functional final product.

A preferred and useful black pigment for the dark-colored vacuum coating is available from BASF and can be shown to possess the IR properties desired, namely that the pigment system is substantially transmissive of NIR and such a pigment system is used in the inventive examples discussed, hereinbelow. A UV-cured, “100% solid” or “100% transfer” vacuum coating suitable for use in the invention is available from Composite Coatings Incorporated (“CCI”). This CCI vacuum coating is a monomer, oligomer, polymer, vacuum coating that is cured by photo initiators along with a secondary heat activation cure. This useful CCI vacuum coating using the black BASF pigment provides a suitable base to which other pigments can be added to achieve a desired particular color or chroma (e.g., forest green or bronze) as is well understood by color houses and those of ordinary skill in the art. Individual pigments may be reflective or transmissive of NIR so long as, overall, the pigment system is substantially NIR transmissive. The preferred CCI vacuum coating, or a substitute that is substantially NIR transparent and UV-cured, would be suitable for use in the present invention and would achieve the ends of the present invention. Further, touch-up paints that are substantially NIR transparent based on similar NIR transmissive pigment systems may be used to repair minor scratches or gaps in the dark colored vacuum coating such as may occur at the corner welds in a window frame.

Suitable IR reflective substrates are available from various sources or may be custom blended depending on IR reflectivity requirements but typically can comprise a white outdoor suitable polymer such as extrusions suitable for exterior use in a high solar exposure environment. A preferred IR reflective substrate is bright white hollow PVC window lineals containing 9 parts TiO₂ per 100 parts base PVC resin (9 phr TiO₂) further including various additives, modifiers and process aids as is well understood in the art. The inventor believe that lineals currently used in residential window frames would likely be a suitable substrate for this invention although the substrate NIR reflective properties may be adjusted as further described hereinbelow. Further, various pastel PVC lineals, in such shades as almond and adobe, and PVC wood-grain colored lineals may be useful so long as the lineals are IR reflective.

A preferred embodiment of the base extrudate would be a foamed PVC (with various additives, modifiers, process aids and blowing agents) base extruded by the base extruder. A further base extrudate would be a hollow PVC lineal that does not contain significant amounts of TiO₂ to reduce the base extrudate cost. A preferred IR reflective capstock would be a bright white PVC capstock with 10 phr TiO₂. Further, capstocks of various polymers in white and in various pastel colors, such as almond and adobe, or wood-grain colored capstocks may be used so long as the capstock is IR reflective.

An important concept to practicing this invention is the correlation between coating thickness and the amount of NIR transmittance. A thicker coating sample transmits less of NIR while a thinner sample transmits more. Since reflectance is dominated by the surface of the dark-colored vacuum coating, the NIR that is not transmitted by the thicker coating sample is absorbed by the dark-colored vacuum coating causing increased heat build-up for the thicker dark-colored vacuum coated extrusion of the present invention. This illustrates the importance of the first means for limiting heat build-up in the inventive process; namely the decreasing of the thickness of the dark-colored vacuum coating to minimize NIR absorbance as NIR initially passes through the dark-colored capstock and as it is reflected off of the substrate back through the dark-colored capstock.

The second consideration is that the substrate is manipulated to provide the requisite NIR reflectance and most commonly increased or decreased by manipulating the loading of TiO₂ with consideration of other substrate constituents. It should be noted that, as the TiO₂ level of the substrate is increased, the percent NIR reflectance also increases. Thus, by increasing the NIR reflectance of the substrate by increasing the TiO₂ level one can increase the percent NIR reflectance of an extrusion with the inventive dark colored vacuum coating.

In contrast, prior art coatings do not appear to be effected in a significant way by the TiO₂ level as the prior art dark vacuum coatings would not be affected by the NIR reflectance of the substrate as essentially all of the NIR is either reflected or absorbed by prior art dark colored vacuum coatings not NIR transmissive.

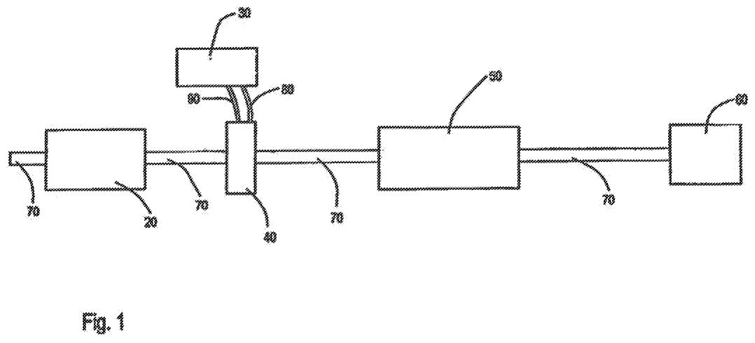

FIG. 1 illustrates a vacuum coating line 10 suitable for practicing the inventive process. The vacuum coating line 10 consists of a cleaning station 20, a vacuum pump and supply apparatus 30, a vacuum coating gate and mask apparatus 40, a primary UV oven 50 and a secondary UV oven 60, which act upon the PVC or other plastic extruded profile 70. The profile 70 is typically approximately twenty feet long, but may be of whatever length is preferred or required.

Cleaning station 20 preferably consists of brushes to remove any dust or other particle on the profile 70 along with an acetone bath shroud to remove any oils or other contaminants from the profiles surface.

Vacuum pump and supply apparatus 30 is a typical unit used in the vacuum coating industry and comprises a vacuum pump along with a vacuum coating supply reservoir. The Vacuum pump and supply apparatus 30 is connected to the vacuum coating gate and mask apparatus 40 with supply line 80 and return line 90.

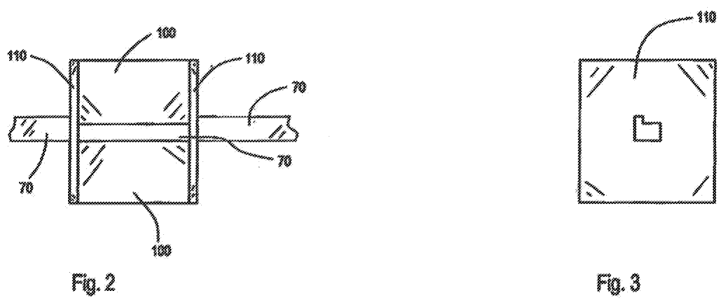

FIG. 2 is a top view of the vacuum coating gate and mask apparatus 40 showing an illustrative mask with the top removed while FIG. 3 is a plan view of the vacuum coating gate and mask apparatus 40 showing an illustrative mask 100 and an illustrative gate 110. As is well understood in the vacuum coating art, profile 70 is fed through an upstream gate 110 with the portions of the profile 70 that are not to be vacuum coated covered by the shroud 100 and profile 70 exits the downstream gate 110. The vacuum coating gate and mask apparatus 40 seals around profile 70 and any air that is drawn in through any surrounding gaps by the vacuum pump and supply apparatus 30 is removed by its associate vacuum pumps. The vacuum coating is deposited onto profile 70 within the gate and mask apparatus 40 as supplied by the supply line 80 from the vacuum pump and supply apparatus 30.

Returning to FIG. 1, profile 70, now coated with a liquid vacuum coating is then fed into primary UV oven 50. Primary UV oven 50 preferably contains gallium arc lamps with dichroic coated quartz lenses to reduce as much as possible the IR component of the lamps' output. The UV output of the gallium lamps provides a cure though the entire depth of the vacuum coating. The heat imparted to the vacuum coating also activates the secondary heat activate curing component in the inventive vacuum coating. One must balance ensuring that the vacuum coating is properly cured by the application of UV and secondarily heat with the concern of imparting too much heat to the underlying profile 70. Where the gallium lamps of primary UV oven 50 are too powerful or are applied to the profile 70 for too long a period, profile 70 may distort or bow and airflow from fans may allow some regulation of the temperature of profile 70. Further, if the vacuum coating is too thick or becomes too opaque due to the pigment loading, found to be greater than about 9% when using the preferred BASF IR transmissive pigment, then the gallium lamp is not able to fully cure the entire thickness of the vacuum coating without causing bowing or distortion of the profile 70 due to excessive heat build-up. A suitable gallium lamp UV oven is available from DV Systems.

The profile 70 is next fed into secondary UV oven 60 which preferably contains microwave driven mercury UV lamps. These lamps also include dichroic coated quartz lenses to reduce the IR component. Inventor has found that these secondary UV mercury lamps further harden the outer surface of the inventive vacuum coating. This additional surface hardness better protects profile 70 during continued processing and handling and packaging immediately following the vacuum coating process. A suitable mercury lamp secondary oven is available from Lincoln Electric.

A preferred embodiment of profile 70 after processing under the inventive vacuum coating line 10 would have a dark-colored UV-cured, with secondary heat curing to ensure curing of non-line-of-sight areas, vacuum coating between 0.6 to 0.8 mils thick and having an IR transmissive pigment level of approximately 9% by weight.

1. A method of producing a low heat build-up extrudate with a dark-colored vacuum coating, comprising the steps of: coating a portion of a surface of an infrared reflective substrate, formed of a first thermoplastic resin that is reflective of solar infrared radiation, with an ultraviolet-cured vacuum coating using a vacuum coating gate and mask apparatus, where the vacuum coating gate and mask apparatus is supplied by a vacuum pump and supply apparatus, the coating being transmissive of near-infrared solar radiation and being dark-colored; the dark colored coating having an Lh value between 13 and 40; the dark colored coating having a thickness of between 0.6 and 0.8 mils; and curing the vacuum coating in a primary ultraviolet oven wherein the extrudate exhibits a predicted horizontal heat build-up under ASTM D4803 of less than about 58.degree. Fahrenheit.

2. The method of claim 1, further comprising the step of further curing the vacuum coating in a secondary ultraviolet oven.

3. The method of claim 2, where the primary ultraviolet oven uses gallium lamps.

4. The method of claim 2, where the secondary ultraviolet oven uses mercury lamps.

5. A method of producing a low heat build-up extrudate with a dark-colored vacuum coating, comprising the steps of: coating a portion of a surface of an infrared reflective substrate, formed of a first thermoplastic resin that is reflective of solar infrared radiation, with an ultraviolet-cured vacuum coating using a vacuum coating gate and mask apparatus, where the vacuum coating gate and mask apparatus is supplied by a vacuum pump and supply apparatus that applies the vacuum coating with a 100 percent solids vacuum coating process, the coating being transmissive of near-infrared solar radiation and being dark-colored; the dark colored coating having an Lh value between 13 and 40; the dark colored coating having a thickness of between 0.6 and 0.8 mils and an infrared transmissive pigment level of approximately 9 percent by weight; and curing the vacuum coating in a primary ultraviolet oven and then further curing the vacuum coating in a secondary ultraviolet oven wherein the extrudate exhibits a predicted horizontal heat build-up under ASTM D4803 of less than about 56.degree. Fahrenheit.

6. The method of claim 5, where the primary ultraviolet oven uses gallium UV lamps.

7. The method of claim 5, where the secondary ultraviolet oven uses mercury lamps.

8. A heat build-up resistant extrudate with a dark-colored vacuum coating, comprising: an IR reflective substrate portion formed of a thermoplastic resin that is substantially reflective of solar infrared radiation, a dark-colored vacuum coating that is formed of a UV-cured vacuum coating that is significantly transmissive of solar infrared radiation and that covers at least a portion of the reflective substrate, and wherein the extrudate exhibits a predicted horizontal heat build-up under ASTM D4803 of less than about 58.degree. Fahrenheit.

9. The extrudate with a dark-colored vacuum coating of claim 8, wherein, the dark-colored UV-cured vacuum coating is less than about 0.8 mils thick, and the thermoplastic resin contains greater than about 8 parts TiO₂ per hundred parts base resin.

10. The extrudate with a dark-colored capstock of claim 9, wherein the dark-colored capstock is between 0.6 and 0.8 mils thick and the first thermoplastic resin contains between 8 and 11 parts TiO₂ per hundred base resin.

11. The extrudate with a dark-colored capstock of claim 8, further comprising a base portion formed of a second thermoplastic resin, wherein, the IR reflective substrate portion covers at least part of the surface of the base portion, and the dark-colored capstock portion covers at least part of the surface of the IR reflective substrate portion.

12. The extrudate with a dark-colored vacuum coating of claim 11, wherein the second thermoplastic resin is a rigid, solid thermoplastic.

13. The extrudate with a dark-colored vacuum coating of claim 12, wherein the second thermoplastic resin is a rigid, foamed thermoplastic resin.

14. The extrudate with a dark-colored vacuum coating of claim 13, wherein the base portion is formed of a rigid, foamed thermoplastic resin and wood flour composite.

15. The extrudate with a dark-colored vacuum coating of claim 13, wherein the base portion is formed of a rigid, foamed thermoplastic resin and mineral filler composite.
